(19) United States
(12) Patent Application Publication
(10) Pub. No.: US 2023/0142494 A1
(43) Pub. Date: May 11, 2023

(54) APPARATUS FOR USE IN TURNING STEERABLE VEHICLE WHEELS

(71) Applicant: ZF Active Safety and Electronics US LLC, Livonia, MI (US)

(72) Inventors: Himadri Shastry, Shelby Township, MI (US); Ramesh Chirla, Washington, MI (US)

(21) Appl. No.: 17/520,784

(22) Filed: Nov. 8, 2021

(51) Int. Cl. B62D 5/04; B62D 5/00

(52) U.S. Cl. CPC B62D 5/0403; B62D 5/0421; B62D 5/0454; B62D 5/046; B62D 5/0448; B62D 5/003

(57) ABSTRACT

An apparatus for use in turning at least one steerable vehicle wheel includes a steering member rotatably supported in a housing. The steering member rotates relative to the housing about a first axis to effect turning movement of the at least one steerable vehicle wheel. A ball nut is connected with an externally threaded portion of the steering member. The steering member is rotatable relative to the ball nut assembly to axially move the ball nut assembly relative to the housing. An electric motor is operable to apply a rotational force to the steering member to urge the steering member to rotate relative to the housing. The electric motor has an output shaft extending along a second axis extending generally parallel to the first axis. A first gear is rotatable about the second axis with the output shaft of the motor. A second gear in meshing engagement with the first gear is rotatable about a third axis extending transverse to the second axis. A third gear is rotatable with the second gear about the third axis. A fourth gear in meshing engagement with the third gear is rotatable with the steering member relative to the housing.

### TECHNICAL FIELD

The present invention relates to an apparatus for use in turning steerable vehicle wheels and, more specifically, to a power steering apparatus for use in turning steerable wheels of a vehicle.

### BACKGROUND

A known steering apparatus includes a steering member which is rotatable to effect turning movement of steerable vehicle wheels. A ball nut is connected with an externally threaded portion of the steering member. The steering member is rotatable relative to the ball nut assembly to axially move the ball nut assembly relative to the housing. An electric motor is operable to apply a rotational force to the steering member to urge the steering member to rotate relative to the housing. The electric motor has an output shaft extending generally perpendicular to the axis of the steering member.

### SUMMARY

An apparatus for use in turning at least one steerable vehicle wheel includes a steering member rotatably supported in a housing. The steering member rotates relative to the housing about a first axis to effect turning movement of the at least one steerable vehicle wheel. A ball nut is connected with an externally threaded portion of the steering member. The steering member is rotatable relative to the ball nut assembly to axially move the ball nut assembly relative to the housing. An electric motor is operable to apply a rotational force to the steering member to urge the steering member to rotate relative to the housing. The electric motor has an output shaft extending along a second axis extending generally parallel to the first axis. A first gear is rotatable about the second axis with the output shaft of the motor. A second gear in meshing engagement with the first gear is rotatable about a third axis extending transverse to the second axis. A third gear is rotatable with the second gear about the third axis. A fourth gear in meshing engagement with the third gear is rotatable with the steering member relative to the housing gear.

### BRIEF DESCRIPTION OF THE DRAWINGS

For a better understanding, reference may be made to the accompanying drawings, which are not to scale unless explicitly noted as such in the below description, and in which:

FIG. 1 is a schematic pictorial view of a steering apparatus constructed in accordance with the present invention;

FIG. 2 is a schematic pictorial view of the steering apparatus of FIG. 1 with portions removed; and

FIG. 3 is a schematic sectional view of a portion of the steering apparatus of FIG. 1.

### DESCRIPTION OF ASPECTS OF THE DISCLOSURE

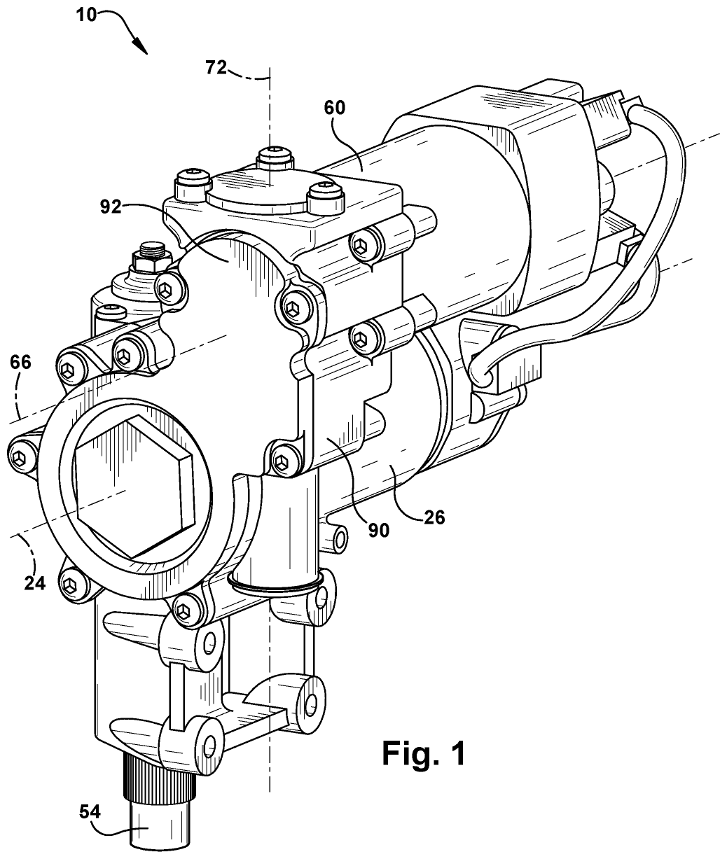

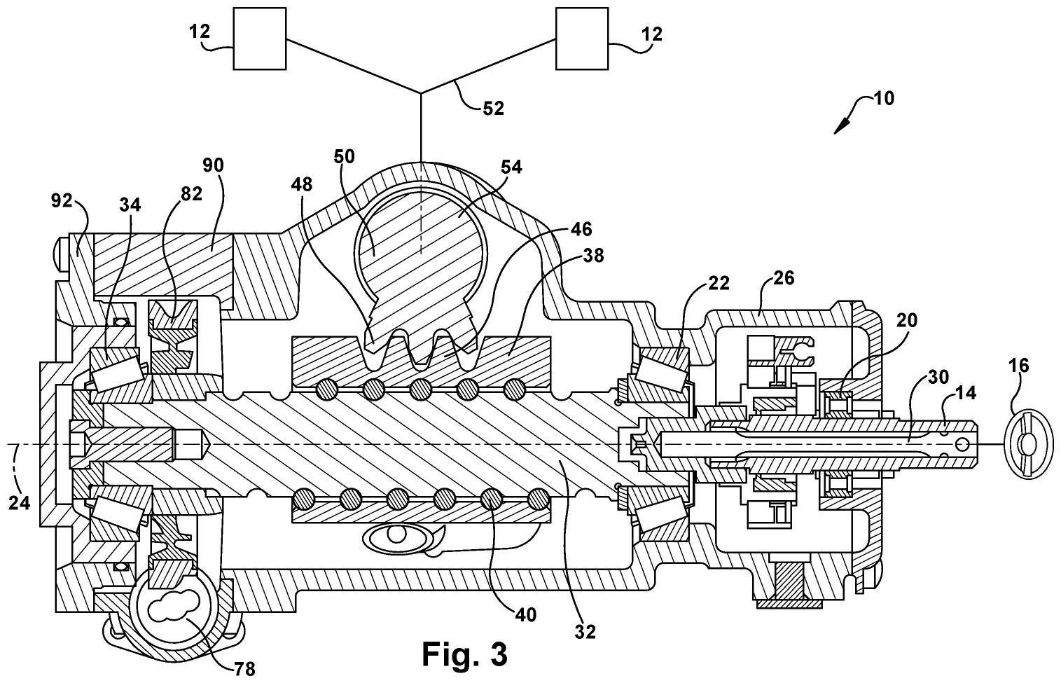

An apparatus 10 for use in turning steerable vehicle wheels 12 constructed in accordance with the present invention is illustrated in FIGS. 1-3. The apparatus 10 (FIG. 3) includes an input shaft 14 which may be operably connected to a steering wheel 16. The input shaft 14 is supported by bearings 20 and 22 for rotation about an axis 24 of the input shaft relative to a housing 26. Upon rotation of the steering wheel 16, force is transmitted through the input shaft 14 to cause rotation of the input shaft relative to the housing 26. Although the input shaft 14 is described as being connected to a steering wheel 16, it is contemplated that the input shaft may be rotated relative to the housing 26 by a motor.

The input shaft 14 is connected to a first end of a torsion bar 30. A second end of the torsion bar 30 is connected to an externally threaded steering member 32. The externally threaded steering member 32 is coaxial with the input shaft 14 and supported by the bearings 22 and bearings 34 for rotation about the axis 24. Therefore, rotation of the input shaft 14 is transferred to the steering member 32. The torsion bar 30 permits relative rotation between the input shaft 14 and the steering member 32. Although the apparatus 10 is described as including a torsion bar 30 that permits relative rotation between the input shaft 14 and the steering member 32, it is contemplated that the steering member 32 may be directly connected to the input shaft 14.

A ball nut 38 extends around an externally threaded portion of the rotatable steering member 32. A plurality of balls 40 interconnects the externally threaded portion of the steering member 32 with an internally threaded portion of the ball nut 38. The ball nut 38 is prevented from rotating relative to the housing 26 so that rotation of the steering member 32 causes axial movement of the ball nut relative to the housing and the steering member 32.

A series of rack teeth 46 is formed on the periphery of the ball nut 38. The rack teeth 46 mesh with teeth 48 formed on a sector gear 50 that is connected with the steerable vehicle wheels 12 by a steering linkage 52. An output shaft 54 may interconnect the sector gear 50 and the steering linkage 52. When the ball nut 38 moves axially, the rack teeth 46 interact with the teeth 48 of the sector gear 50 to rotate the sector gear and output shaft 54 and turn the steerable vehicle wheels 12 in a known manner.

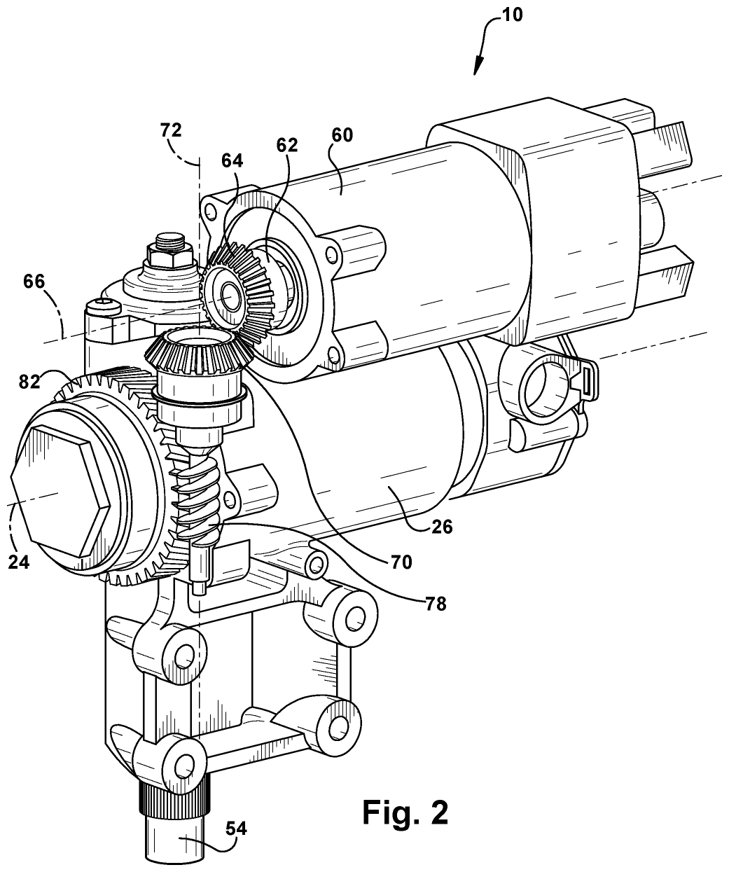

A reversible electric motor 60 (FIGS. 1-2) is operable to apply a rotational force to the steering member 32 to urge the steering member to rotate relative to the housing 26. The electric motor 60 (FIG. 2) has an output shaft 62 connected to a first gear 64. The output shaft 62 of the motor 60 extends along an axis 66 so that the motor rotates the first gear 64 about the axis 66. The axis 66 extends generally parallel to the axis 24 of the input shaft 14 and steering member 32. The first gear 64 may be a miter gear. The first gear 64 is in meshing engagement with a second gear 70. The second gear 70 is supported for rotation about an axis 72 that extends generally transverse to the axis 66. It is contemplated that the axis 72 may extend perpendicular to the axis 66. The second gear 70 may be a miter gear.

A third gear 78 may be connected to the second gear 70. The third gear 78 rotates about the axis 72 with the second gear 70. The third gear 78 may be a worm gear that is in meshing engagement with a fourth gear 82, such as a worm wheel. The fourth gear 82 (FIG. 3) may be connected to the steering member 32 and be supported for rotation about the axis 24 by the bearing 34. The first gear 64, second gear 70, third gear 78 and fourth gear 82 transmit force to the steering member 32 to urge the steering member to rotate about the axis 24 during operation of the motor 60. The first, second, third and fourth gears 64, 70, 78 and 82 permit the motor 60 to be located at any desired position around the axis 24 of the steering member 32 and the housing 26. The motor 60 may be located with the axis 66 of the motor extending parallel to the axis 24 at any desired position about the axis 24 since the third gear 78 may be located around the axis 24.

A gear box 90 (FIG. 1) may interconnect the motor 60 and housing 26. The gear box 90 may support the second and third gears 70, 78 for rotation about the axis 72. A cover 92 may be connected to the gear box 90. Although a specific gear box 90 is shown in FIG. 1, the gear box may have any desired construction for a desired location of the motor 60 relative to the housing 26.

The apparatus 10 (FIG. 1) may include vehicle condition sensors and an electronic control unit for controlling the motor 60 based on sensed vehicle conditions. The vehicle condition sensors may include a torque sensor and a position sensor electrically connected to the ECU. The torque sensor may sense the torque applied to the steering wheel 16 and generate a signal indicative of the torque. The position sensor may sense the rotational position of the steering wheel 16 and generate an electrical signal indicative of the steering wheel position. The electrical signals from the torque sensor and the position sensor are sent to the ECU. The ECU analyzes the output of the sensors and effects operation of the motor 60 as a function of the output of the sensors. In addition, the ECU may have inputs which vary as a function of sensed lateral acceleration of the vehicle or other vehicle operating conditions. The ECU receives the signals generated by the sensors and actuates the motor 60 in order to apply a rotational force to the steering member 32 to assist in turning of the steerable vehicle wheels 12.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for use in turning at least one steerable vehicle wheel comprising:
a steering member rotatably supported in a housing, the steering member rotating relative to the housing about a first axis to effect turning movement of the at least one steerable vehicle wheel, the steering member having an externally threaded portion;
a ball nut connected with the externally threaded portion of the steering member, the steering member being rotatable relative to the ball nut assembly to axially move the ball nut assembly relative to the housing;
an electric motor operably connected with steering member, the motor being operable to apply a rotational force to the steering member to urge the steering member to rotate relative to the housing, the electric motor having an output shaft extending along a second axis extending generally parallel to the first axis;
a first gear rotatable about the second axis with the output shaft of the motor;
a second gear in meshing engagement with the first gear, the second gear being rotatable about a third axis extending transverse to the second axis;
a third gear rotatable with the second gear about the third axis; and
a fourth gear in meshing engagement with the third gear; the fourth gear being rotatable with the steering member relative to the housing.

2. An apparatus for use in turning at least one steerable vehicle wheel as set forth in claim 1 wherein the first and second gears are miter gears.

3. An apparatus for use in turning at least one steerable vehicle wheel as set forth in claim 1 wherein the third gear is a worm gear and the fourth gear is a worm wheel.

4. An apparatus for use in turning at least one steerable vehicle wheel as set forth in claim 1 wherein the fourth gear is rotatable about the first axis relative to the housing.

5. An apparatus for use in turning at least one steerable vehicle wheel as set forth in claim 1 wherein the third axis extends perpendicular to the second axis.

6. An apparatus for use in turning at least one steerable vehicle wheel as set forth in claim 1 wherein a gear box supports the second and third gears for rotation about the third axis.

7. An apparatus for use in turning at least one steerable vehicle wheel as set forth in claim 6 wherein the gear box connects the electric motor to the housing.

8. An apparatus for use in turning at least one steerable vehicle wheel as set forth in claim 1 further including at least one vehicle condition sensor and a control unit connected with the at least one vehicle condition sensor, the at least one vehicle condition sensor providing an output to the control unit, the control unit being connected with the motor and being operable to control the operation of the motor as a function of the output from the at least one vehicle condition sensor.

9. An apparatus for use in turning at least one steerable vehicle wheel as set forth in claim 1 wherein the first and second gears are miter gears, the third gear is a worm gear and the fourth gear is a worm wheel.
